(19) United States
(12) Patent Application Publication
(10) Pub. No.: US 2020/0243318 A1
(43) Pub. Date: Jul. 30, 2020

(54) MATRlX FILM DEPOSITION SYSTEM

(71) Applicant: SHIMADZU CORPORATION, Kyoto-shi, Kyoto (JP)

(72) Inventor: Kenta TERASHIMA, Kyoto-shi, Kyoto (JP)

(73) Assignee: SHIMADZU CORPORATION, Kyoto-shi, Kyoto (JP)

(21) Appl. No.: 16/755,955

(22) PCT Filed: Nov. 30, 2017
(86) PCT No.: PCT/JP2017/043145

§ 371 Date: Apr. 14, 2020

(51) Int. Cl. H01J 49/16

(52) U.S. Cl. CPC H01J 49/164

(57) ABSTRACT

A matrix film deposition system for forming a film of a matrix substance on a sample plate used for mass spectrometric imaging is provided with a nebulizing nozzle 20 including a solution tube 21 and a gas tube 22, gas feeders 40, 41, 42, and 46 configured to feed high-pressure gas to the proximal end of the gas tube 22, and pressurization solution feeders 40, 41, 42, 48, 30, and 31 configured to pressurize a solution containing a matrix substance and to feed the solution to a proximal end of the solution tube 21. Due to this, it is possible to prevent the matrix solution near the tip of the solution tube 21 from staying, and to prevent the nebulizing nozzle 20 from clogging due to formation of crystalline mass in the solution tube 21.

### TECHNICAL FIELD

The present invention relates to a matrix film deposition system for depositing a film of a matrix substance on a sample plate which is to be used in mass spectrometric imaging using a matrix assisted laser desorption/ionization (MALDI) method.

### BACKGROUND ART

MALDI method is an ionization technique suitable for an analysis of a sample which barely absorbs laser light or one which is easily damaged by laser light (such as proteins). In this technique, a matrix substance which easily absorbs laser light and which is easily ionized is previously mixed in the sample which is a measurement target and the obtained mixture is irradiated with laser light to ionize the sample. Generally, the matrix substance initially added to a sample is as a solution, and this matrix solution incorporates the measurement target substance contained in the sample. Subsequently, the solvent in the solution is vaporized by being dried to form crystalline grains containing the measurement target substance. Then, those grains are irradiated with laser light, whereby the measurement target substance is ionized due to interaction among the measurement target substance, matrix substance, and laser light. MALDI method has been widely applied in the areas of bioscience and others since use of it enables an analysis of polymer compounds having high molecular weights without significantly dissociating them, and furthermore, since it is highly sensitive and suitable for microanalysis.

Furthermore, in recent years, attention has been attracted on a mass spectrometric imaging (MS imaging) method for directly visualizing the two-dimensional distribution situation of biomolecules and metabolites on a slice of biological tissue using a MALDI mass spectrometer. With a mass spectrometric imaging method, a two-dimensional image showing the intensity distribution of an ion having a specific mass-to-charge ratio on a sample such as a slice of biological tissue can be obtained. The mass spectrometric imaging method is expected to be variously applied in medical, drug development, life science, and other fields in order to grasp a spread situation of a disease and to confirm a therapeutic effect of medication or the like by examining the distribution situation of substances specific to pathological tissues such as cancer, for example.

General methods for preparing a sample, i.e., adding a matrix substance to a sample in the mass spectrometric imaging method include a method (hereinafter referred to as spray method) of spraying and applying the matrix solution onto a plate where the sample is put (see Patent Literature 1, for example). FIG. 3 shows a schematic configuration of a matrix film deposition system for preparing a sample using the spray method. This matrix film deposition system includes a chamber 80 housing a sample stage 81 to which a sample plate P is to be attached, and a nebulizing nozzle 70 for spraying a matrix substance onto the sample plate P. The nebulizing nozzle 70 includes a gas tube 72 through which nebulizing gas flows, and a solution tube 71 through which the matrix solution flows, These have a double-tube structure in which the solution tube 71 is inserted inside the gas tube 72, and the tip of the solution tube 71 is surrounded by the tip of the gas tube 72, A needle 73 is inserted into the center of the solution tube 71, and the tip of the needle 73 slightly projects from the tip of the solution tube 71. The inside of the solution tube 71 is filled with a matrix solution, and its proximal end is inserted into a solution container 75 containing the matrix solution. The proximal end of the gas tube 72 is connected to a gas source 74 such as a gas cylinder.

Since the tip of the solution tube 71 is surrounded by the tip of the gas tube 72 as described above, when high-pressure nebulizing gas supplied from the gas source 74 is ejected from the tip of the gas tube 72, the vicinity of the tip of the solution tube 71 is depressurized (Venturi effect), and the matrix solution is drawn out from the tip. The matrix solution drawn out from the tip of the solution tube 71 is sheared by the nebulizing gas and broken into droplets, and the droplets are carried by the nebulizing gas flow and ejected from the nozzle 70. At this time, the matrix solution flows along the needle 73 so as to improve the shearing efficiency of the matrix solution by the nebulizing gas, allowing the droplets to be further miniaturized. The matrix solution injected from the nebulizing nozzle 70 as described above adheres to the sample plate P on the sample stage 81 facing the nebulizing nozzle 70.

### CITATION LIST

### Patent Literature

Patent Literature 1: JP 2016-114400 A ([0004])

### SUMMARY OF INVENTION

### Technical Problem

The inner diameter of the tip of the solution tube 71 in the nebulizing nozzle 70 of the above-described matrix film deposition system is as very small as about 0.3 mm, and the nebulizing gas flow facilitates drying of the matrix solution. Hence, a crystalline mass of the matrix is easily formed at the tip of the solution tube 71. When the crystalline mass is formed, the nozzle 70 is clogged. Hence, it has been necessary to appropriately remove the crystalline mass by hand or dissolve the crystalline mass by clipping the tip of the nozzle 70 to a cup or the like containing a solvent.

The present invention has been developed in view of the previously described point. Its objective is to suppress a nebulizing nozzle from clogging in a matrix film deposition system for forming a film of a matrix substance on a sample plate used for mass spectrometric imaging.

### Solution to Problem

The matrix film deposition system according to the present invention aimed at solving the previously described problem includes

a) a nebulizing nozzle including a solution tube which is a tubular passage, and a gas tube which is a passage extending in parallel with the solution tube and whose tip is located in a region near the tip of the solution tube,

b) a gas feeder configured to feed high-pressure gas to the proximal end of the gas tube, and

c) a pressurization solution feeder configured to pressurize a solution containing a matrix substance used for the matrix assisted laser desorption/ionization method and to feed it to the proximal end of the solution tube.

According to the above configuration, by pressurizing and sending the solution containing the matrix substance (matrix solution) to the solution tube of the nebulizing nozzle, the formation of crystals of the matrix substance in the nebulizing nozzle is suppressed, and clogging of the nozzle can be prevented. In the present invention, the tip of the gas tube “is located in a region near the tip of the solution tube” means that the tip of the gas tube is located at a distance in which the solution flowing out of the tip of the solution tube is sheared by the gas ejected from the tip of the gas tube and broken into droplets. The “high-pressure gas” means a gas having a pressure higher than the atmospheric pressure in absolute pressure.

Additionally, the matrix film deposition system according to the present invention should preferably include:

d) a controller configured to control the gas feeder and the pressurization solution feeder so as to perform a nozzle cleaning mode, in which the solution is fed by the pressurization solution feeder in a state where the feeding of the gas to the gas tube by the gas feeder is stopped.

As described above, by performing the “nozzle cleaning mode” in which the matrix solution is fed to the nebulizing nozzle in a state where the feeding of the gas to the nebulizing nozzle is stopped, crystals of the matrix substance formed inside and at the tip of the solution tube can be removed by dissolving in the matrix solution. With this, it is possible to realize stable nebulizing by preventing the passage from being narrowed due to the adhesion of crystals. used. However, in order to prevent fluctuation in the introduction amount due to pulsation of the pump, the pressurization solution feeder preferably performs pressurization and sending solution by pressurizing the liquid surface of the matrix solution.

In one mode of the matrix film deposition system according to the present invention, the pressurization solution feeder preferably includes:

an airtight container in which the solution is stored,

a solution pipe of which one end is connected to the proximal end of the solution tube and the other end is arranged at a lower portion in the airtight container, and

a pressurizing gas introducer configured to introduce gas into an upper space in the airtight container.

Here, the “upper space” means a space above the liquid surface of the matrix solution inside the airtight container.

When the matrix solution is sent by pressurizing the liquid surface of the matrix solution with gas as described above, the gas for pressurizing the liquid surface and the gas supplied to the nebulizing nozzle are preferably supplied from the same gas source.

In another mode of the matrix film deposition system according to the present invention, the gas feeder preferably includes:

a gas source configured to supply an inert gas and a gas passage connecting the proximal end of the gas tube with the gas source, wherein

the pressurizing gas introducer introduces an inert gas supplied from the gas source provided in the gas feeder into an upper space in the airtight container.

In yet another mode of the matrix film deposition system according to the present invention, the pressurization solution feeder preferably includes:

a solution container containing the solution, and

a resistance tube having a passage resistance larger than a passage resistance in the solution tube, the resistance tube inserted on a solution passage from the solution container to the proximal end of the solution tube.

By providing such a resistance tube, the effect of the passage resistance fluctuation in the nebulizing nozzle due to narrowing of the passage due to the adhesion of crystals, a difference in the mounting condition of the needle, fluctuation of the relative position of each component due to processing errors, or the like can be relatively reduced, and it is thus possible to always perform nebulizing with a constant amount.

### Advantageous Effects of Invention

As described above, according to the matrix film deposition system according to the present invention, clogging of the nebulizing nozzle due to the formation of crystals of the matrix solution in the nebulizing nozzle can be prevented.

### BRIEF DESCRIPTION OF DRAWINGS

FIG. 1 is a schematic configuration diagram showing the main section of a matrix film deposition system according to one embodiment of the present invention.

FIG. 2 is a flowchart showing an operation at the time of nozzle cleaning in the same embodiment.

FIG. 3 is a schematic configuration diagram of a conventional spray-type matrix film deposition system.

### DESCRIPTION OF EMBODIMENTS

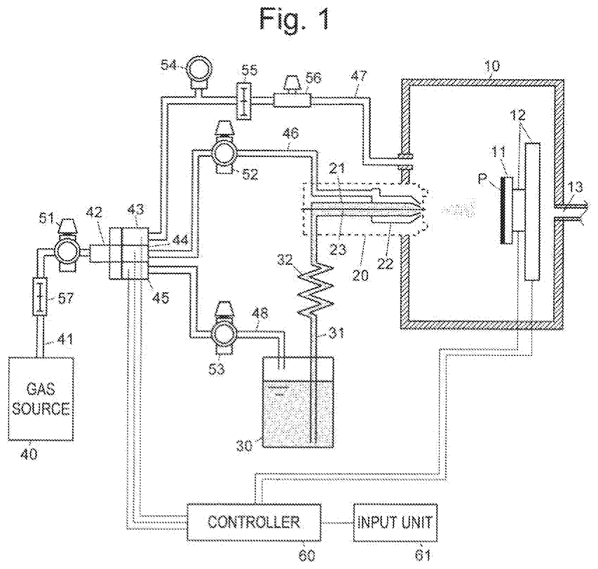

Hereinafter, embodiments for carrying out the present invention will be described with reference to the drawings. FIG. 1 is a schematic configuration diagram showing the main section of a matrix film deposition system according to the present embodiment. The matrix film deposition system according to the present embodiment has a chamber 10 housing a sample plate P, and a nebulizing nozzle 20 for spraying a matrix solution (solution containing a matrix substance) onto the sample plate P.

Inside the chamber 10, a sample stage 11 to which the sample plate P is to be attached and an XY stage 12 for moving the sample stage 11 are housed. One of the wall surfaces of the chamber 10 is provided with a door (not shown) for taking in and out the sample plate P, and the nebulizing nozzle 20 is attached to a wall surface of the chamber 10 facing the sample stage 11. An evacuating hole 13 is formed on any of the wall surfaces of the chamber 10, and the evacuating hole 13 is connected to a draft chamber (not shown)

The nebulizing nozzle 20 has a double-tube structure having a solution tube 21 and a gas tube 22 which is arranged coaxially with the solution tube 21 in such a manner as to serve as the external cylinder surrounding the solution tube 21. The solution tube 21 has an inner diameter of about 0.3 mm at the tip, and a needle 23 for guiding the solution at the time of nebulizing is inserted into the center of the solution tube 21. The tip of the solution tube 21 and the tip of the gas tube 22 are substantially at the same position in the length direction of the tubes 21 and 22, and the tip of the needle 23 slightly projects from the tip of the solution tube 21.

At the proximal end of the solution tube 21, one end of a solution supply tube 31 (corresponding to the “solution pipe” or the “solution passage” in the present invention) is connected, and the other end of the solution supply tube 31 is arranged at a lower region of a solution container 30 (below the center in the height direction of the solution container 30, preferably near the bottom surface), which is an airtight container containing the matrix solution. A resistance tube 32 is inserted in an intermediate region of the solution supply tube 31. As the resistance tube 32, a tube having a sufficiently large resistance value compared to the resistance value at the tip of the solution tube 21 of the nebulizing nozzle 20, for example, a capillary tube having an inner diameter of 0.075 mm and a length of 20 mm is used. As the resistance tube 32, a capillary made of silica, a capillary made of PEEK (polyetheretherketone) resin, or the like can be used. In consideration of durability, it is preferable to use a PEEK capillary.

One end of a nebulizing gas pipe 46 is connected to the proximal end of the gas tube 22 and the other end of the nebulizing gas pipe 46 is connected to a gas source 40 via a manifold (multi-branch tube) 42 and a common pipe 41. The gas source 40 includes, for example, a gas cylinder or a gas generator, and sends out an inert gas (e.g., nitrogen gas) having a pressure higher than the atmospheric pressure to the common pipe 41. Here, the common pipe 41, the manifold 42, and the nebulizing gas pipe 46 correspond to the “gas passage” in the present invention. The manifold 42 has one inlet end and three outlet ends, where the common pipe 41 is connected to the inlet end, and the nebulizing gas pipe 46 is connected to one of the three outlet ends. One of the remaining two outlet ends of the manifold 42 is connected to one end of a replacing gas pipe 47, and the other of the remaining two outlet ends of the manifold 42 is connected to one end of a pressurizing gas pipe 48. The other end of the replacing gas pipe 47 is located on the wall surface of the chamber 10, and the other end of the pressurizing gas pipe 48 is located near the ceiling inside the solution container 30 (at least above the center in the height direction of the solution container 30). An electromagnetic valve is mounted on each of the three outlet ends of the manifold 42. Hereinafter, of these electromagnetic valves, the one provided at the outlet end to which the replacing gas pipe 47 is connected is referred to as a gas replacing valve 43, the one provided at the outlet end to which the nebulizing gas pipe 46 is connected is referred to as a nebulizing valve 44, and the one at the outlet end to which the pressurizing gas pipe 48 is connected is referred to as a pressurizing valve 45. In the above configuration, the gas source 40, the common pipe 41, the manifold 42, the nebulizing valve 44, and the nebulizing gas pipe 46 correspond to the “gas feeder” in the present invention. The gas source 40, the common pipe 41, the manifold 42, the pressurizing valve 45, and the pressurizing gas pipe 48 correspond to the “pressurizing gas introducer” in the present invention, and the pressurizing gas introducer, the solution container 30, the solution supply tube 31, and the resistance tube 32 cooperate to function as a “pressurization solution feeder” in the present invention.

The common pipe 41, the nebulizing gas pipe 46, and the pressurizing gas pipe 48 are provided with manual pressure-regulating valves 51, 52, and 53, respectively. The replacing gas pipe 47 is provided with a pressure gauge 54, a flowmeter 55, and a manual flow-regulating valve 56.

The matrix film deposition system according to the present embodiment has a controller 60 for controlling the operations of the XY stage 12 and the electromagnetic valves 43, 44, and 45. The controller 60 is connected with an input unit 61 for the user to input setting and instructions. The function of the controller 60 is implemented by causing a computer having a CPU and a memory to execute a predetermined control program.

When performing deposition by the matrix film deposition system according to the present embodiment, first, a worker (hereinafter, referred to as a user) opens a door of the chamber 10 and attaches, to the sample stage 11, the sample plate P on which a thin film sample such as a slice of tissue is put. Subsequently, the user closes the door of the chamber 10, manually adjusts the opening of the pressure-regulating valves 51, 52, and 53 as necessary, and then operates the input unit 61 to input an instruction of starting deposition. While in the present embodiment, the pressure-regulating valves 51, 52, and 53 are manually operated, they may be driven by a motor, and the opening of the pressure-regulating valves 51, 52, and 53 may be adjusted by the user via the controller 60.

When an instruction of starting deposition is input from the input unit 61, the controller 60 first sends a control signal to the gas replacing valve 43 to open the valve 43. Due to this, an inert gas supplied from the gas source 40 flows into the chamber 10 via the manifold 42 and the replacing gas pipe 47, and the air in the chamber 10 is replaced with the inert gas.

After that, at the time when a sufficient time has elapsed for the air in the chamber 10 to be completely replaced with the inert gas, the controller 60 sends a control signal to the pressurizing valve 45 to open the valve 45. Due to this, the inert gas supplied from the gas source 40 to the manifold 42 flows also into the pressurizing gas pipe 48. As a result, the inert gas is introduced into the upper space of the solution container 30 from the tip of the pressurizing gas pipe 48, and the gas pressurizes the liquid surface of the matrix solution in the solution container 30. As a result, the matrix solution is introduced into the solution supply tube 31, and is discharged from the solution tube 21 of the nebulizing nozzle 20 via the resistance tube 32.

Subsequently, the controller 60 sends a control signal to the nebulizing valve 44 to open the valve 44. Due to this, the inert gas supplied from the gas source 40 to the manifold 42 further flows also into the nebulizing gas pipe 46. Here, the pressurizing valve 45 and the nebulizing valve 44 are opened in this order, but these valves 44 and 45 may be opened in reverse order or may be opened simultaneously.

Due to the above, the inert gas is ejected from the tip of the gas tube 22 of the nebulizing nozzle 20, and the matrix solution flowing out from the tip of the solution tube 21 is sheared by the gas, broken into droplets, and is injected from the nebulizing nozzle 20 together with the gas.

When the nebulizing of the matrix substance is started, the controller 60 subsequently sends a control signal to the XY stage 12. Due to this, the XY stage 12 moves the sample stage 11 so that the matrix solution is nebulized uniformly onto the entire surface of the sample plate P.

After that, at the time when the matrix solution has been nebulized onto the entire surface of the sample plate P. the controller 60 stops the XY stage 12, further closes the gas replacing valve 43, the nebulizing valve 44, and the pressurizing valve 45, and stops the gas replacement in the chamber 10 and the nebulizing of the matrix substance. Due to the above, when the nebulizing of the matrix substance onto the sample plate P is completed, the user opens the door of the chamber 10 and takes out the sample plate P. After that, if deposition is subsequently performed onto another sample plate P, a new sample plate P is set onto the sample stage 11, and the above operation is repeatedly performed.

As described above, in the matrix film deposition system according to the present embodiment, by pressurizing and sending the matrix solution, it is possible to prevent the matrix solution near the tip of the solution tube 21 from staying, and to prevent the nebulizing nozzle 20 from clogging due to formation of crystalline mass. By inserting the resistance tube 32 having a passage resistance larger than the passage resistance in the solution tube 21 on the solution passage from the solution container 30 to the proximal end of the solution tube 21. it is possible to reduce the ratio of the passage resistance of the solution tube 21 to the passage resistance of the entire passage. As a result, even if the passage resistance of the solution tube 21 fluctuates due to narrowing of the passage due to the adhesion of crystals, a difference in the mounting condition of the needle, fluctuation of the relative position of each component due to processing errors, or the like, it is possible to prevent a large change in the nebulizing amount from occurring.

Even in the case of performing the above-described pressurization and sending solution, while continuing the nebulizing, the nebulizing amount may fluctuate due to adhesion of crystals of the matrix solution in the solution tube 21, and it is hence preferable to clean the nebulizing nozzle 20 as needed.

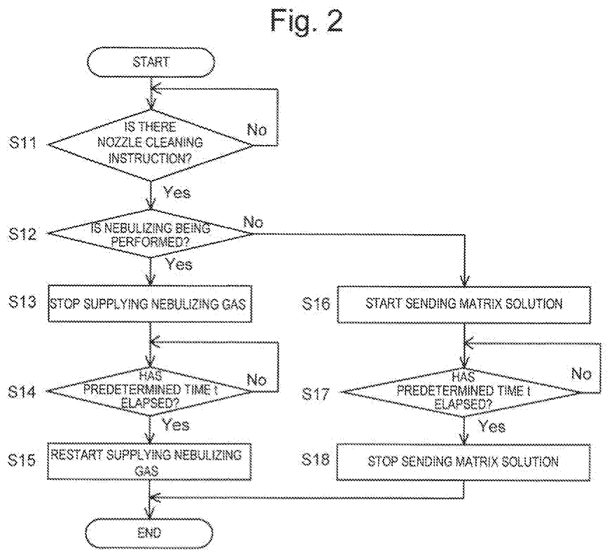

FIG. 2 is a flowchart showing an operation at the time of nozzle cleaning of the matrix film deposition system according to the present embodiment. An operation mode in which only the matrix solution is supplied without supplying gas to the nebulizing nozzle 20 as described below corresponds to the “cleaning mode” in the present invention.

When cleaning of the nebulizing nozzle 20 is instructed by a user operation on the input unit 61, the effect is input to the controller 60 (Yes in step S11). The controller 60 having received the nozzle cleaning instruction first determines whether or not nebulizing of the matrix substance by the nebulizing nozzle 20 is currently being performed (step S12).

If nebulizing is being performed (Yes in step S12), the gas supply to the nebulizing nozzle 20 is stopped by closing the nebulizing valve 44 (step S13). Due to this, only the matrix solution is supplied to the nebulizing nozzle 20, and hence the matrix solution flows out from the tip of the solution tube 21 without being sheared by gas. At this time, the crystal of the matrix substance existing at the tip of the nebulizing nozzle 20 is removed by being dissolved by the matrix solution. When a predetermined time t has elapsed from the stop of the supply of the nebulizing gas (Yes in step S14), the controller 60 opens the nebulizing valve 44 to restart the supply of the nebulizing gas (step S15). When performing nozzle cleaning during performing nebulizing in this manner, it is preferable to drive the XY stage 12 in advance to retract the sample plate P in the chamber 10 from the front of the nebulizing nozzle 20.

On the other hand, if nebulizing of the matrix substance is not being performed at the time of receiving the nozzle cleaning instruction (No in step S12), the controller 60 opens the pressurizing valve 45 to start sending the matrix solution to the nebulizing nozzle 20 (step S16). At this time, since no gas has been supplied to the nebulizing nozzle 20, similar to the above, the matrix solution introduced into the solution tube 21 flows out from the tip of the solution tube 21 while dissolving the crystal of the matrix substance without being sheared by gas. After that, when the predetermined time t has elapsed (Yes in step S17), the controller 60 closes the pressurizing valve 45 to stop the sending of the matrix solution to the nebulizing nozzle 20 (step S18).

Here, it is assumed that the nozzle cleaning is finished at the time when the predetermined time t has elapsed. However, instead of this, the nozzle cleaning may be finished at the time when the user instructs finish of the nozzle cleaning (i.e., at the time when a cleaning finish instruction is input from the input unit 61 to the controller 60). Alternatively, the nozzle cleaning may be finished at the time when a predetermined amount of matrix solution has been sent after the cleaning is started. In this case, the controller 60 calculates the solution sending amount (i.e., amount of matrix solution having been nebulized) from the time of starting the cleaning on the basis of information such as the pressure of the inert gas supplied to the solution container 30 and the length and diameter of the resistance tube 32, for example. In addition to or instead of the above-described configuration in which nozzle cleaning is started in response to an instruction from the user, nozzle cleaning may be started at the time when a predetermined time has elapsed from the start of nebulizing of the matrix substance or at the time when a predetermined amount of the matrix solution has been sent after the previous cleaning has been performed. In the latter case, the solution sending amount can be calculated by the controller 60 by providing a flowmeter in the solution supply tube 31 in the same manner as described above.

As described above, the embodiment for carrying out the present invention has been described. However, the present invention is not limited to the above-described embodiment, and is allowed to be appropriately changed within the scope of the present invention. For example, in the above-described embodiment, the matrix film deposition system according to the present invention performs nebulizing of a matrix substance by the spray method. However, the present invention is not limited to this, and is also applicable to a device for nebulizing a matrix substance by the electrospray deposition (ESD) method (see Patent Literature 1). The ESD method is to apply a direct-current voltage to a solution tube, to charge the matrix solution in the solution tube by an electric field formed by this, and then to perform injection with gas. The present invention can be applied in the same manner as described above, because it uses a nebulizing nozzle including a solution tube and a gas tube which extends in parallel with the solution tube and whose tip is located in a region near the tip of the solution tube, similar to the spray method.

In the above-described embodiment, the sample plate P is moved by the XY stage 12. Alternatively, the nebulizing nozzle 20 may be moved in a plane parallel to the sample plate P.

Furthermore, in the above-described embodiment, solution sending is performed by pressurizing the liquid surface of the matrix solution in the solution container 30 with the gas supplied from the gas source 40. However, another method, e.g., performing pressurization and sending a matrix solution using a syringe pump is also possible.

In addition to be configured so that the supply of the matrix solution to the solution tube is always performed by pressurization and sending a solution, the matrix film deposition system according to the present invention may also be configured so that the solution supply by pressurization and sending a solution and the solution supply by the Venturi effect (i.e., not performing pressurizing) can be executed in a switching manner. In this case, it becomes possible that, for example, a mechanism for switching the solution container 30 between the airtight state and the open-to-atmosphere state by opening and closing the lid of the solution container 30 is provided, solution supply by the Venturi effect is performed, at the time of nebulizing the matrixsolution, by opening the solution container to the atmosphere and closing the pressurizing valve 45, and pressurization and sending a solution are performed by making the solution container 30 airtight and opening the pressurizing valve 45 at the time of executing the cleaning mode.

### EXAMPLES

Hereinafter, a test conducted for confirming the effects of pressurization and sending the matrix solution and cleaning of the nebulizing nozzle will be described.

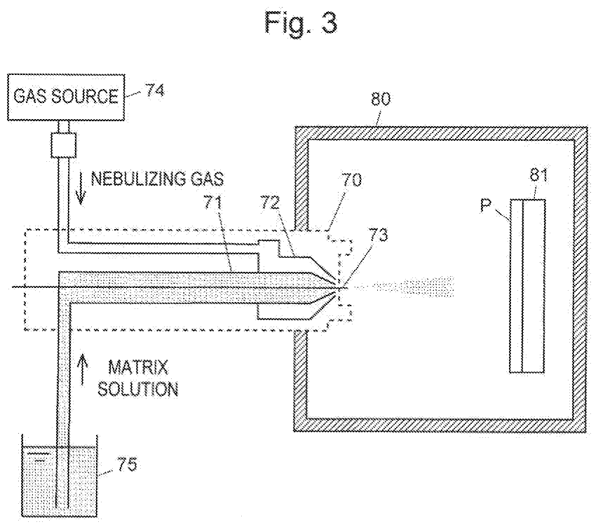

First, using a conventional matrix film deposition system as shown in FIG. 3, the amount of the matrix solution that can be continuously nebulized without performing pressurization and sending a solution was examined. As the nebulizing nozzle 20, one including the solution tube 21 having an inner diameter of 0.3 mm and a tip opening area of 0.012 mm² was used, and as a matrix solution, 30 μg/mL of 2,5-dihydroxybenzoic acid (DHB) solution was used. A nitrogen generator was used as the gas source 40, and a pressure-regulating valve (not shown) provided on the pipe was adjusted so that the gas pressure during nebulizing in the pipe connecting the gas source 40 with the gas tube 22 was 0.1 MPa. Under the above conditions, the matrix solution was continuously nebulized, and the amount of matrix substance having been nebulized at the time when the nebulizing nozzle 20 was completely clogged was confirmed.

The results of conducting the above test for five times are shown in Table 1 below (when nebulizing up to 500 μL was possible, “no clogging”).

TABLE 1

| | Solution usage amount at time of |
|---|---|
| | occurrence of clogging (μL) |
| First time | 300 |
| Second time | No clogging |
| Third time | 300 |
| Fourth time | 400 |
| Fifth time | No clogging |

From the above, it is confirmed that the nebulizing nozzle is sometimes completely clogged when 300 μL of the matrix solution is nebulized.

Subsequently, using the matrix film deposition system according to the present invention as shown in FIG. 1, the nebulizing performance was evaluated when the matrix solution was pressurized and sent and the nozzle cleaning was performed every 5 minutes.

As the nebulizing nozzle 20, one including the solution tube 21 having an inner diameter of 0.3 mm and a tip opening area of 0.014 mm² was used, and as a matrix solution, 30 mg/mL of 2,5-dihydroxybenzoic acid (DHB) solution was used. A nitrogen generator was used as the gas source 40, the pressure-regulating valve 52 was adjusted so that the gas pressure in the nebulizing gas pipe 46 at the time of opening the nebulizing valve 44 was 0.1 MPa, and the pressure-regulating valve 53 was adjusted so that the gas pressure in the pressurizing gas pipe 48 at the time of opening the pressurizing valve 45 was 0.16 MPa. At the time of nebulizing, the gas in the chamber 10 was replaced by introducing dry nitrogen generated in the gas source 40 into the chamber 10 at a flow rate of 25 L/min for one minute in advance, and also during nebulizing, the introduction of the dry nitrogen to the chamber 10 was continued.

Under the above conditions, the matrix substance was nebulized, and the amount of matrix substance having been nebulized was confirmed every five minutes (confirmation of the decrease amount of the matrix solution amount in the solution container 30), and the nebulizing nozzle 20 was cleaned. The nozzle cleaning was performed by maintaining for ten seconds the gas pressure in the nebulizing gas pipe 46 to 0.1 MPa with the nebulizing valve 44 closed while maintaining the gas pressure in the pressurizing gas pipe 48 to 0.16 MPa. In one test, the above-described nebulizing for five minutes, confirmation of the nebulizing amount, and nozzle cleaning were repeated six times.

Table 2 below shows the usage amount of the matrix solution obtained by conducting the above test three times.

TABLE 2

| | Solution usage amount | | |
|---|---|---|---|
| Time (min) | First time (μL) | Second time (μL) | Third time (μL) |
| 5 | 165 | 169.4 | 168.3 |
| 10 | 162.8 | 166.1 | 166.1 |
| 15 | 162.8 | 168.3 | 168.3 |
| 20 | 162.8 | 169.4 | 166.1 |
| 25 | 160.6 | 171.6 | 166.1 |
| 30 | 167.2 | 170.5 | 166.1 |
| 35 | 162.8 | 172.7 | 163.9 |

Table 3 below shows the results of obtaining the maximum value, the minimum value, and the average value from the above result, and calculating how much the nebulizing amount varies.

TABLE 3

| | | |
|---|---|---|
| Maximum | 172.7 | μL |
| Minimum | 160.6 | μL |
| Average | 166.519 | μL |
| Fluctuation | 3.711859 | % |

As described above, according to the matrix film deposition system according to the present invention, nozzle clogging does not occur even when the total nebulizing amount exceeds 1000 μL, and it is possible to perform nebulizing with a nebulizing amount fluctuation for every 5 minutes being within ±5%.

### REFERENCE SIGNS LIST

10, 80 . . . Chamber
11, 81 . . . Sample Stage
12 . . . XY Stage
13 . . . Evacuating Hole
20, 70 . . . Nebulizing Nozzle
21, 71 . . . Solution Tube
22, 72 . . . Gas Tube
23, 73 . . . Needle
30, 75 . . . Solution Container
31 . . . Solution Supply Tube
32 . . . Resistance Tube
40, 74 . . . Gas Source
41 . . . Common Pipe
42 . . . Manifold
43 . . . Gas Replacing Valve
44 . . . Nebulizing Valve
45 . . . Pressurizing Valve
46 . . . Nebulizing Gas Pipe
47 . . . Replacing Gas Pipe
48 . . . Pressurizing Gas Pipe
51, 52, 53 . . . Pressure-regulating Tube
60 . . . Controller
61 . . . Input Unit

1. A matrix film deposition system, comprising:
a) a nebulizing nozzle including a solution tube which is a tubular passage, and a gas tube which is a passage extending in parallel with the solution tube and whose tip is located in a region near a tip of the solution tube;
b) a gas feeder configured to feed high-pressure gas to a proximal end of the gas tube; and
c) a pressurization solution feeder configured to pressurize a solution containing a matrix substance used for a matrix assisted laser desorption/ionization method and to feed the solution to a proximal end of the solution tube.

2. The matrix film deposition system according to claim 1, further comprising:
d) a controller configured to control the gas feeder and the pressurization solution feeder so as to perform a nozzle cleaning mode, in which the solution is fed by the pressurization solution feeder in a state where feeding of gas to the gas tube by the gas feeder is stopped.

3. The matrix film deposition system according to claim 1, wherein
the pressurization solution feeder includes
e) an airtight container in which the solution is stored,
f) a solution pipe of which one end is connected to a proximal end of the solution tube and another end is arranged at a lower portion in the airtight container, and
g) a pressurizing gas introducer configured to introduce gas into an upper space in the airtight container.

4. The matrix film deposition system according to claim 3, wherein
the gas feeder includes
h) a gas source configured to supply an inert gas and
i) a gas passage connecting a proximal end of the gas tube with the gas source, wherein
the pressurizing gas introducer introduces an inert gas supplied from the gas source provided in the gas feeder into an upper space in the airtight container.

5. The matrix film deposition system according to claim 1, wherein
the pressurization solution feeder includes
j) a solution container containing the solution, and
k) a resistance tube having a passage resistance larger than a passage resistance in the solution tube, the resistance tube inserted on a solution passage from the solution container to a proximal end of the solution tube.
